(19) United States
(12) Patent Application Publication
(10) Pub. No.: US 2011/0247016 A1
(43) Pub. Date: Oct. 6, 2011

(54) METHOD FOR GENERATING CROSS PLATFORM PROGRAM AND MIDDLEWARE PLATFORM ENGINE THEREOF

(76) Inventor: Young-Sook Seong, Seoul (KR)

(21) Appl. No.: 12/523,694

(22) PCT Filed: Jan. 22, 2008
(86) PCT No.: PCT/KR2008/000405

§ 371 Date: Jul. 17, 2009

(30) Foreign Application Priority Data
Nov. 22, 2007 (KR) 10-2007-0006770

(51) Int. Cl. G06F 9/44

(52) U.S. Cl. 719/328

(57) ABSTRACT

A method for porting a cross platform program between heterogeneous platforms and a middleware platform engine therefor are provided. The method for porting an API from a source middleware platform to a target middleware platform includes storing index numbers assigned a plurality of source APIs in a memory associated with a source middleware platform; extracting at least one of the indexes, which is required for generating a target API and corresponds to the source API; and generating the at least one target API using the at least source API indicated by the at least one index. The method and middleware platform engine of the present invention is advantageous to reducing porting time of the conventionally developed 3D games between heterogeneous platforms.

### TECHNICAL FIELD

The present invention relates to a cross platform program and, in particular, to a method for porting a program between devices equipped with heterogeneous middleware platforms and a middleware platform engine therefor.

### BACKGROUND ART

Wireless Internet Platform for Interoperability (WIPI) is a middleware platform developed to execute native binary formats while maintaining advantages of Java language. Typically, wireless Internet platforms are implemented in either virtual machine (VM) or native binary technology, and there are tradeoffs in using the VM and native binary technologies.

A VM is a software implementation of a machine that executes programs like a real machine. In the VM technology, a program is converted to an intermediated code so as to be executed in a software central processing unit (CPU). The VM interprets the intermediate code into machine language.

The VM technology has widely used, and Java virtual machine (JVM) has been adopted as one of wireless Internet platforms. Also, a general virtual machine (GVM), which is written in mini-C, is developed and GVM-based services are provided in South Korea.

In the native binary technology, a program is compiled to be executed. That is, a developed program is converted into machine language that can be run on a CPU. One of the native binary technology-based wireless Internet platforms is Binary Runtime Environment for Wireless (BREW) created by Qualcomm. In the VM-based wireless Internet platform, a software CPU should interpret the program into intermediate code, whereby a user may experience a processing delay in CPU and resource-constrained mobile phones. However, the VM-based platform is advantageous to providing relatively high system stability and security.

In the meantime, the native binary-based platform can utilize 100% of the CPU capability, unlike the VM-based platform requiring intermediate code interpretation, so as to provide high execution speed. However, since the native binary technologies are typically written in C/C++ as the program language, invalid or malicious memory access may occur, resulting in system instability. WIPI platform has been developed with the advantages of both the VM and native binary technologies. That is, the WIPI platform provides the advantages of Java language while maintaining high execution performance of native binary code.

WIPI platform allows developing programs in C/C++ and Java languages and allows the application to secure the execution performance of native binary. In the case of C/C++, there is no problem to generate native binary code. However, the Java language is designed in consideration of virtual machine such that the java should be compiled into device-executable binary code. Compile On Demand (COD) is a component responsible for generating the executable binary code in WIPI.

With the recent emerge of game phones, there has been need for premium game services. For this reason, it is required to achieve interoperability between WIPI and APIs based on the conventional Open GL and Direct X and secure performance enough for running games on the device.

Also, it is required to facilitate development of games and develop a game engine optimized for a mobile environment by implementing mobile game middleware in a dynamic link method. Preferably, such middleware should be designed in consideration of mobile device evolution and improvement of mobile architecture so as to be accommodated in various development environments.

### DISCLOSURE OF INVENTION

### Technical Problem

The present invention has been made in an effort to solve the above problems, and it is an object of the present invention to provide a method and middleware platform engine for porting a program between devices having heterogeneous middleware platforms, thereby reducing porting time.

It is another object of the present invention to provide a method and middleware platform engine for porting a program between devices having heterogeneous middleware platforms that is capable of promoting mobile game business by improving inter-platform operability.

The above and other objects are accomplished by a method and middle platform layer for porting a program described hereinafter.

### Technical Solution

In accordance with an aspect of the present invention, a method for porting an API from a source middleware platform to a target middleware platform includes storing index numbers assigned a plurality of source APIs in a memory associated with a source middleware platform; extracting at least one of the indexes, which is required for generating a target API and corresponds to the source API; and generating the at least one target API using the at least source API indicated by the at least one index.

Preferably, storing index numbers includes extracting at least one code executable on a target middleware platform engine and storing the at least one code.

Preferably, calling one of the indexes includes extracting at least one target code corresponding to the at least one index.

Preferably, generating at least one target API includes creating the at least one target API by combining the at least on target code.

In accordance with another aspect of the present invention, a middleware platform engine for porting application programming interfaces between devices having different middleware platforms includes a storage unit for assigning index numbers to a plurality of source APIs and storing the index numbers within a memory; an index caller for calling at least one index number of at least one source API corresponding to at least one target API; an API generator for generating the at least one target API using the at least source API indicated by the at least one index.

Preferably, the storage unit extracts at least one code executable on a target middleware platform from the at least one source API.

Preferably, the index caller extracts at least one code corresponding to the at least one index number.

Preferably, the API generator generates the at least one target API by combining the at least on target code.

Preferably, the middleware platform engine further includes at least one of a graphic library, a media library, a physics library, and an artificial intelligence (AI) library, corresponding to a structure of the at least one target API.

Preferably, the media library is a graphic library or a sound library.

### ADVANTAGEOUS EFFECTS

The method and middleware platform engine of the present invention is advantageous to reducing porting time of the conventionally developed 3-dimensional (3D) games between heterogeneous platforms.

Also, the method and middleware platform engine of the present invention allow operating various mobile games on heterogeneous platforms, thereby promoting the mobile game business.

### BRIEF DESCRIPTION OF THE DRAWINGS

The above and other objects, features and advantages of the present invention will be more apparent from the following detailed description in conjunction with the accompanying drawings, in which:

FIG. 1 is a diagram illustrating an architecture of a device having a cross platform program generation apparatus according to an exemplary embodiment of the present invention;

FIG. 2 is a block diagram illustrating a program porting mechanism according to an exemplary embodiment of the present invention;

FIG. 3 is a block diagram illustrating device architecture according to another exemplary embodiment of the present invention;

FIG. 4 is a block diagram illustrating a method for generating an API function in a cross platform program generation apparatus according to an exemplary embodiment of the present invention;

FIG. 5 is a block diagram illustrating a method for generating an API function in a cross platform program generation apparatus according to another exemplary embodiment of the present invention;

FIG. 6 is a block diagram illustrating a method for generating an API function in a cross platform program generation apparatus according to another exemplary embodiment of the present invention;

FIG. 7 is a block diagram illustrating a method for generating an API function in a cross platform program generation apparatus according to another exemplary embodiment of the present invention;

FIG. 8 is a block diagram illustrating a configuration of a program development tool of a cross platform program generation apparatus according to an exemplary embodiment of the present invention;

FIG. 9 is a block diagram illustrating a program development environment by a program development tool of a cross platform program porting method according to an exemplary embodiment of the present invention;

FIG. 10 is a block diagram illustrating a configuration of a program development tool according to an exemplary embodiment of the present invention;

FIG. 11 is a block diagram illustrating a compiler of the program development tool according to an exemplary embodiment of the present invention;

FIG. 12 is a block diagram illustrating a configuration of a memory utilization mechanism of the cross platform program porting apparatus according to an exemplary embodiment of the present invention; and

FIG. 13 is a block diagram illustrating a relationship between the UI tool and memory of the cross platform program porting apparatus according to an exemplary embodiment of the present invention.

### MODE FOR THE INVENTION

Exemplary embodiments of the present invention are described with reference to the accompanying drawings in detail. Although the invention is described in detail with reference to specific embodiments thereof, it will be understood that variations which are functionally equivalent are within the scope of this invention.

In the following, the terms including ordinal numbers such as “first” and “second” can be used for describing diverse elements. However, the elements are not limited by the terms. Such terms are only used for distinguish the elements from each other. For example, a first element may be renamed as a second element, and a second element may be renamed as a first element. The term “and/or” is used to denote a combination of associated multiple elements or one of the associated multiple elements.

When it is said that an element is “connected to” or “associated with” another element, the elements may be directly connected to or associated with each other, however, it may be understood that a third element is interposed in between. Meanwhile, when it is said that an element is “directly connected to” or “directly associated with” each other, it must be understood that no other element is involved in between.

The following definitions are provided to enable a clear and consistent understanding of the detailed description. Unless otherwise noted, singular expressions include plural expressions. In the following, the word “include” or “have” is only used for designating existence of features, numbers, steps, operations, elements, parts, or combination thereof disclosed in the descriptions, but not for excluding one or more other features, numbers, steps, operations, elements, parts, or combination thereof.

Unless otherwise noted, all the terms including technical and scientific terms used in the following description are to be understood according to conventional usage by those skilled in the relevant art. The terms defined in generally used dictionaries are to be understood identical as in the context of related art. Unless otherwise noted in the present invention, it must not be interpreted in ideal or excessive meaning.

The same reference numbers are used throughout the drawings to refer to the same or like parts. Detailed descriptions of well-known functions and structures incorporated herein may be omitted to avoid obscuring the subject matter of the present invention.

The middleware platform layer for porting program between heterogeneous platforms may include an apparatus for generating a cross platform program. In the following, the entire structure of the present invention is described, focusing on the apparatus for generation the cross platform program.

FIG. 1 is a diagram illustrating device architecture according to an exemplary embodiment of the present invention. Referring to FIG. 1, the handset architecture includes an application layer 110, a middleware adaptation layer 120, a library layer 130, a framework layer 140, a middleware platform engine layer 150, a heterogeneous runtime engine layer 160, Handset Adaptation Layer (HAL) 170, a Handset Hardware & Native System Software layer 180, and an Application Program Interfaces (APIs) 190.

The application layer 110 includes the highest layer application programs, e.g., game programs. In this embodiment, the present invention is described in association with the game programs as application programs. In order to simplify the explanation, the present invention is described with reference to a case in that the programs designed for a personal computer (PC) environment are converted to programs executable in a mobile environment (for example, mobile phone, or post PC environment). Of course, program porting can be performed from the mobile environment to the PC environment.

The middleware adaptation layer 120 is responsible for operability of cross platform programs. The middleware adaptation layer 120 includes an API extracting unit for extracting a target API corresponding to a source API and numbers of the source APIs and target APIs. The middleware adaptation layer 120 may include an API mapping unit for mapping the source APIs to the target APIs in consideration of the numbers of the source and target APIs. Here, the source API is an API before being converted, and the target API is an API created corresponding to the source API. The source or target API may be one of functions such as DirectX, Open Graphics Language (OpenGL), OpenGL Embedded Systems (OpenGL ES), and RenderWare.

In a case of mapping the DirectX to the OpenGL ES, the middleware adaptation layer 120 supports a DirectX module to facilitate porting a general PC game designed on the windows platform.

In a case of mapping the OpenGL to the OpenGL ES, the middleware adaptation layer 120 supports porting the games designed on the Linux platform and games and contents developed using the OpenGL. The OpenGL ES, which partially supports the Open GL, can be enhanced with other functions of the Open GL.

In a case of mapping the RenderWare to the OpenGL ES, the middleware adaptation layer 120 supports porting the games developed using the RenderWare providing a cross-platform development environment for game console such playstation 2 (PS2), PS3, Xbox, and GameCube, PC, PSP, and N-gate. The middleware adaptation layer 120 supports porting PS games and other platform-based games.

In a case of supporting extended library based on OpenGL ES, the middleware adaptation layer 120 may provide a development library for improving the functions and performances extended on the basis of basic AP in the mobile phones and portable terminals having an OpenGL ES chip.

The library layer 130 provides a set of libraries to be executed on the converted programs. For example, the library layer 130 is provided with game libraries optimized to the mobile communication terminals and post PC platform. The libraries include graphic, animation, sound, Physics, AI, and Ext libraries.

The framework layer 140 provides a mobile environment frames including platform, hardware (H/W), Interface (I/F), etc.

The middleware platform engine 150 is provided with an engine selector for selecting a middleware engine and a mobile environment engine. Here, the middleware engine includes a storage module which assigns index numbers to the source APIs and stores the API in a memory together with the index numbers, an index calling module which calls an index number of a source API required for creating a corresponding target API, and an API generation module for creating the target API using the source API indicated by the index number.

The storage module extracts a code required for a platform on which the target API is executed from the source API. At this time, the index calling module further extracts a code corresponding to the index number, and the API generates the target API by combining the codes.

That is, the middleware platform engine 150 can create the target API using the functions selected at the middleware adaptation layer 120 by API, function, and structure, respectively.

The heterogeneous runtime engine layer 160, HAL 170, and Handset Hardware & Native System Software layer 180 are layers conventionally implemented in the mobile environment. That is, these lower layers are implemented with hardware and software that are interoperate with APIs 190 including 2D API, 3D API, M&U API, Eglx API, and extended API.

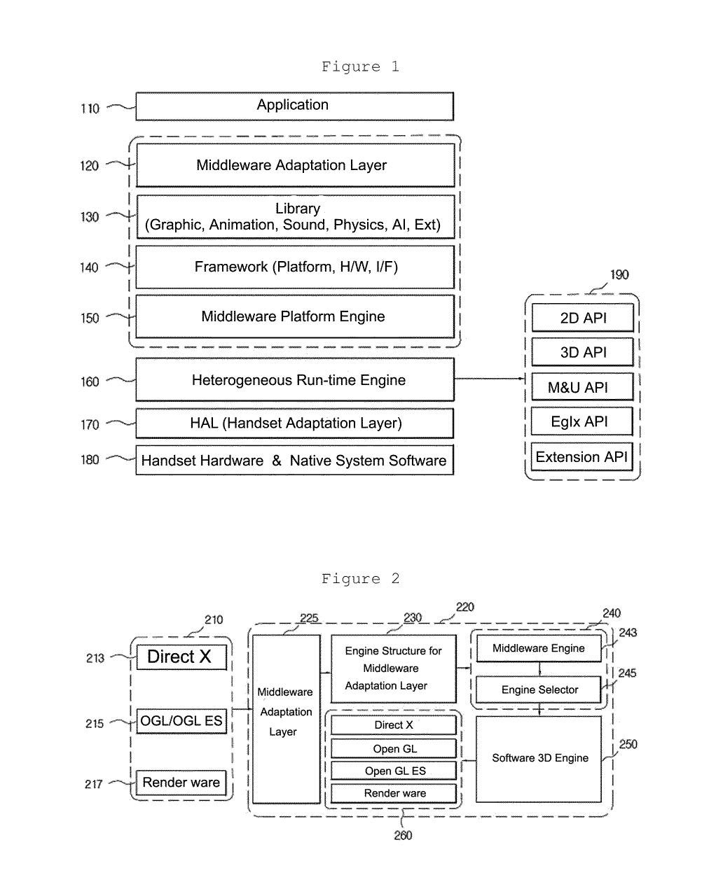

FIG. 2 is a block diagram illustrating a program porting mechanism according to an exemplary embodiment of the present invention. In FIG. 2, a source API 210 and a second platform architecture 220 are depicted. The second platform architecture 220 includes a middle adaptation layer 225, a middleware adaptation layer engine 230, a middleware platform engine 240, a software 3D engine 250, and a target API 260. The descriptions are focused on different structures and functions.

The source API 210 can be one of a DirectX 213, an OpenGL/OpenGL ES 215, and a RenderWare 217. The function and memory structures used in the API 210 differ from those of the target API 260. Accordingly, the middleware adaptation layer 225, middleware adaptation layer engine 230, and the middleware platform engine 240 modify the structure of a function so as to generate the target API 260 appropriate for the second platform 220.

The middleware adaptation layer engine 230 modifies the functions of the source API 210 extracted appropriately for the target API 260 at the middleware adaptation layer 225 in the form of the middleware platform engine 240.

The middleware platform engine 240 includes a middleware engine 243 and an engine selector 245. As described above, the middleware engine 243 generates a target API using the functions of the source API. The target API is selected by the engine selector 245 so as to be executed on the corresponding software engine 250.

The software 3D engine 250 receives the target API 260 output by the engine selector 245 and executes the target API 260. Here, the software 3D engine 250 is of executing 3D. The present invention is not limited to 3D.

FIG. 3 is a block diagram illustrating device architecture according to another exemplary embodiment of the present invention. The descriptions are focused on different structures and functions.

The target API created by the middleware platform engine 150 is executed on a second platform 350. An architecture of the second platform 350 can be selectively operated with a HAL and a Handset Hardware & Native System Software 353, PDA or Mobile Set 356, and Operating System (OS) 359.

Accordingly, the target API can be modified by the middleware platform engine 150 so as to be appropriate for the second platform 350.

Until now, the structures and functions of the device for porting a cross platform program has been described. How to convert an API function in the above described device architecture is described hereinafter in the forms of exemplary embodiments. However, the present invention is not limited to these embodiments.

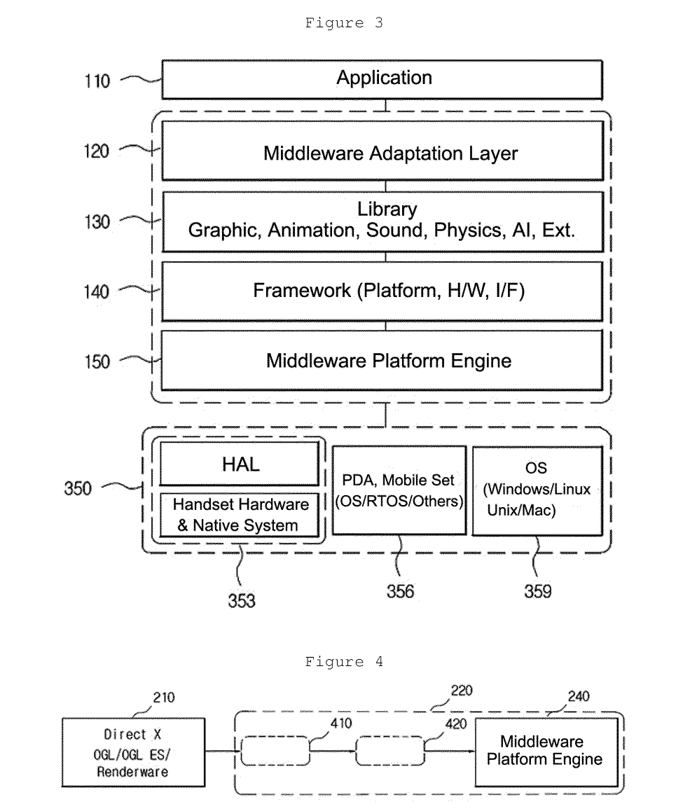

FIG. 4 is a block diagram illustrating a method for generating an API function in a cross platform program generation apparatus according to an exemplary embodiment of the present invention.

In a case that a source API 210 corresponds to a target API, a factor 420 required for generating the target API is extracted from a factor 410 of the source API. Here, the factor 410 is extracted from a function or a code of the source API 210 and may be one of the elements required for creating a target API. The factor 420 required for creating the target API can used for generating the target API by the middleware platform engine 240.

In a case that one source API 210 corresponds to a target API, only one API functions or code of the source API is analyzed to extracted required factor, thereby generating the target API easily.

In order to extract the factor, the API extractor or middleware platform engine 240 may compare the structures of the source and target APIs with each other. The structures of the two APIs are identical with each other, the middleware platform engine 240 can directly convert the source API to the target API. If the structures of the two APIs are not identical with each other, the API extractor or the middle platform engine 240 extracts a similar factor and generates the target API using the extracted factor.

The extracted factors 410 and 420 are stored in the memory and called whenever they are required. The extracted factors 410 and 420 can be directly stored in the memory as they are. Also, only the indexes or memory addresses of the factors 410 and 420 can be stored. In this case, the factors can be called using the indexes or memory addresses.

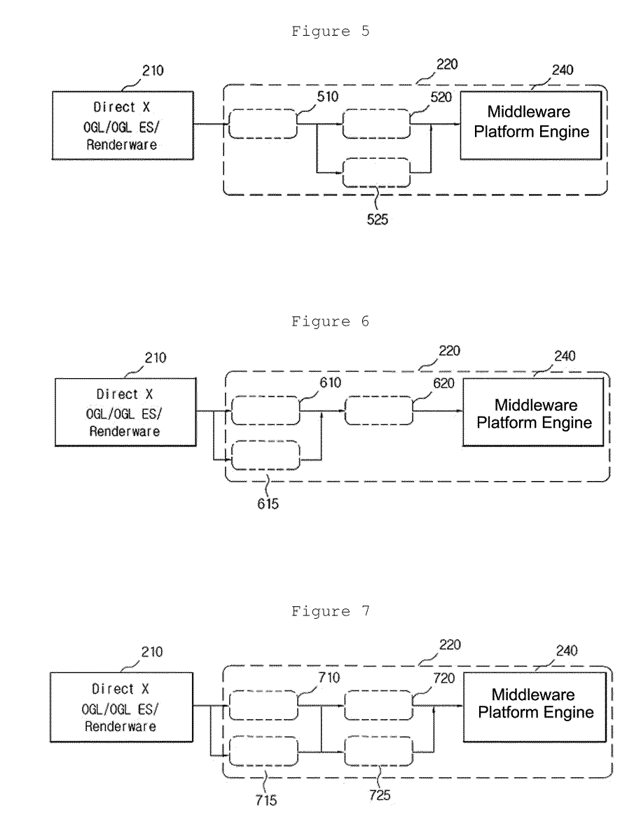

FIG. 5 is a block diagram illustrating a method for generating an API function in a cross platform program generation apparatus according to another exemplary embodiment of the present invention.

In a case that a source API 210 corresponds to plural target API, plural factors 520 and 525 of the target APIs are extracted from a factor 510 of the source API. Here, the factor 510 is extracted from a function or code of the source API 210 and modified to the factors 520 and 530 required from generating the target API.

Although the case in which one factor extracted from a source API corresponds to plural target APIs, plural APIs 520 and 525 may corresponds to a single API.

FIG. 6 is a block diagram illustrating a method for generating an API function in a cross platform program generation apparatus according to another exemplary embodiment of the present invention.

In a case that plural source APIs 210 correspond to a single target API, a factor 520 required for generating the target API is extracted from factors of the plural source APIs 610 and 615.

FIG. 7 is a block diagram illustrating a method for generating an API function in a cross platform program generation apparatus according to another exemplary embodiment of the present invention.

In a case that plural source APIs 210 correspond to plural target APIs, plural factors 710 and 725 required for generating the plural APIs are extracted from plural factors 710 and 715 of plural source APIs. Of course, the plural factors 720 can be used for generating a single target API.

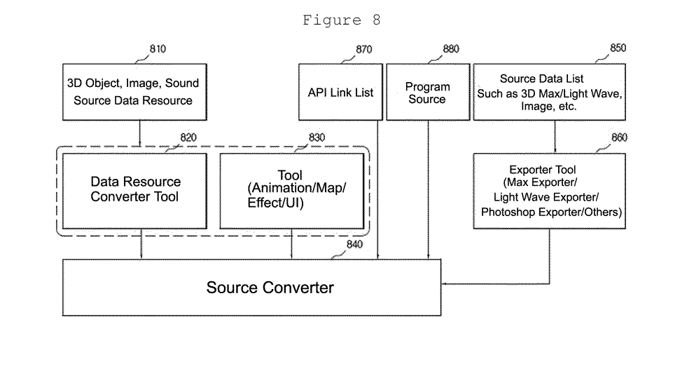

FIG. 8 is a block diagram illustrating a configuration of a program development tool of a cross platform program generation apparatus according to an exemplary embodiment of the present invention.

Referring to FIG. 8, the program development tool is provided with source data resources 810 and 850, a resource converter 820, a tool 830, a source converter 840, an exporter 860, an API link list 870, and a program source 880. In this embodiment, it is assumed that the program is a game program.

The program development tool according to an embodiment of the present invention includes a function extractor for extracting a specific function from the source API, a memory address generator for generating a memory address corresponding to the function, and an API converter for extracting a function of a source API by calling a memory address and generating a target API using the extracted functions.

The functions required for generating the target APIs are stored in a predetermined memory in the form of blocks. The functions are called by means of memory address such that a target API is generated using an extracted function.

The source data resources 810 and 850 are original data including 3D objects, Images, sounds, 3D Max/Light wave data, etc.

The resource converter 820 converts the resources of the source API functions into a platform format corresponding to the target API. That is, the resource converter 820 converts the resources including 2D, 3D, animation, moving picture, and sound data of a program (e.g., a game) operating on a platform so as to be appropriate for a second platform (e.g., mobile format), and optimizes the converted resources.

The tool 830 converts the data associated with animations, maps, effects, and UIs into another types of data appropriated for the second platform. For example, the animation tool of the tool 830 combines the animations, created using 3D Max and Lightwave, by mesh.

The mapping tool can load a Map Tile Pattern configuration on the tool 830 in association with a background and automatically designates the loaded Map Tile on the map by cell. The mapping tool also sets a map size by power of 2 and sets the height of a terrain by cell using RGB values of bitmap pixels or a brush provided on the tool. The mapping tool is also provided with functions for setting fog and light (functions for setting brightness and color of the light and the thickness of the fog by map). In this case, the mapping tool allows arranging objects constituting a map by cell. The mapping tool also sets attributes (non-movable, movable, and safe area) by cell. Using this function, the moving routes of objects can be specified by object. For example, mobile object (mob), non-player character (NPC), and character can be independently assigned their routes by object.

The UI tool of the tool 830 is implemented so as to minimize the involvement of the programmer while programming an interface and optimize the amount of the graphic data. A resource tool supports TGA, BMP, and other file format. The resource tool slices resources constituting a bitmap in appropriate size and assigns the sliced tiles IDs. The resource tool also assigns an automatic combination pattern of the resources required for an interface to the action of a creation button.

The interface tool among the UI tools manages interfaces of games by folder and configuring each folder. The interface tool also supports composing an interface using the ID and pattern assigned by the resource tool. The interface tool designates an initial opening position of the interface and shortcut keys, manages texts on the interface as separate files, and configures an alpha blend level of the interface.

The source converter 840 converts library of a source API so as to be of a platform format of the target API. The source converter 840 is responsible for automatically converting the DirectX, OpenGL, and RenderWare Graphic libraries to be appropriate for the mobile game middleware platform structure. The source converter 840 converts the DirectX, Renderware, and OpenGL libraries into middleware platform libraries (e.g., DirectX->penGL ES or RenderWare->penGL ES).

The exporter 860 converts contents of the source API so as to be of platform format of the target API. The exporter 860 is responsible for converting the 2D, 3D, and motion graphic images to be of formats appropriate for the mobile environment. For example, the exporter 860 is provided with an explorer program for converting a 3D graphic image created by using the 3D Max to a mobile 3D format, and converting other contents such as Photoshop and Audio Video Interleave (AVI) files to a format appropriate for the mobile environment.

The API Link List 870 is provided with API link list values for linking the DirectX,

RenderWare, and OpenGL libraries to the middle platform libraries.

The program source 880 is provided with the original program sources. For example, the program source 880 may include game program sources, content program sources, etc.

Here, the program source 880 may include intermediate data generated by a complier (see FIG. 11). The API Link List 870 and source program 880 can be selectively provided.

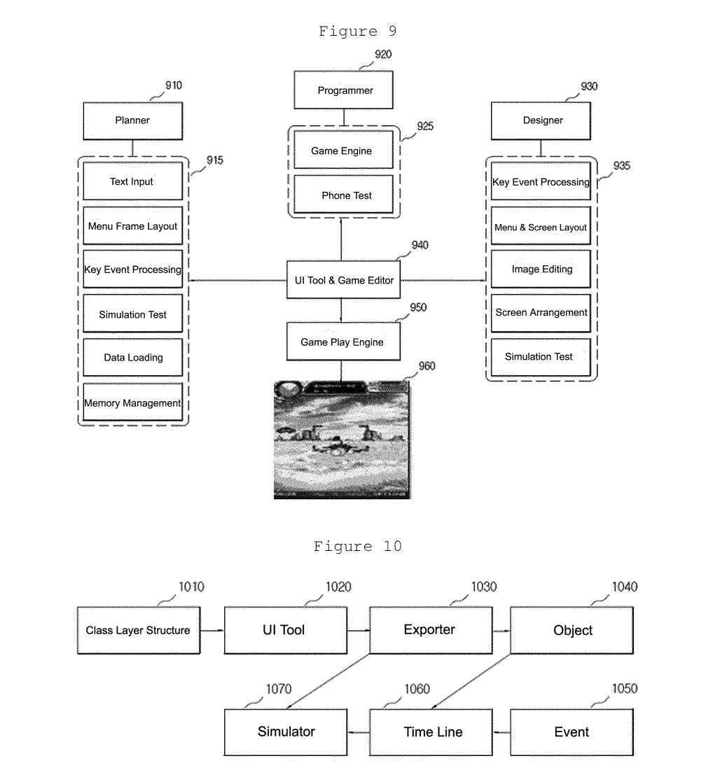

FIG. 9 is a block diagram illustrating a program development environment by a program development tool of a cross platform program porting method according to an exemplary embodiment of the present invention. Referring to FIG. 9, the program development environment includes a planning part 910, a programming part 920, and a designing part 930.

The planning part 910 is responsible for the tasks 915 such as text input, menu frame configuration, key event processing, simulation test, data loading, and memory management.

The programming part 920 is responsible for the tasks 925 such as game engine development and phone tests.

The designing part 930 is responsible for the tasks 930 such as key event processing, menu/window configuration, image design, screen layout, and simulation test.

The planning part 910, programming part 920, and designing part 930 cooperate for efficiently developing the game program using the above described UI tools and game editor 940. The game developed using the UI tools and game editor 940 is finally created as a game program 960 by a game play engine 950.

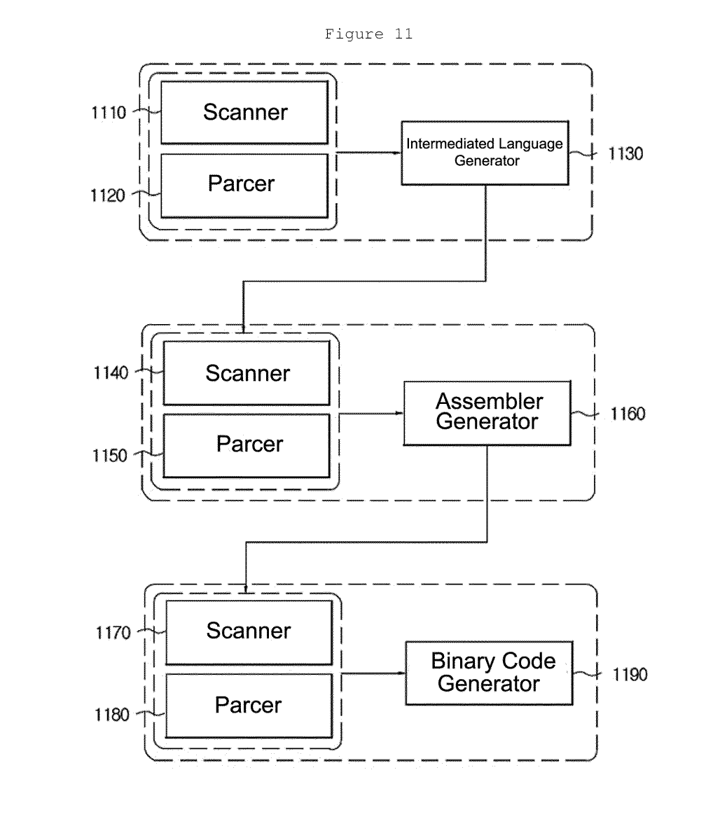

FIG. 10 is a block diagram illustrating a configuration of a program development tool according to an exemplary embodiment of the present invention. Referring to FIG. 10, the program development tool includes a class layer structure 1010, a UI tool 1020, an exporter 1030, an object 1040, an event 1050, a time line 1060, and a simulator 1070.

The class layer structure 101 is designed such that identical functions and resources can be inherited and reused.

The UI tool 1020 collects raw image and graphic data to create a user interface data.

The exporter 1030 reprocesses raw sources such as images (BMP, PNG), graphics, texts, and sounds so as to be appropriate for a second platform format, and the UI tool and game editor 940 generates available object 1040. The object is arranged on the time line 1060 such that the simulator 1070 simulates the resources and events assigned to the respective frames.

The simulator 1070 is provided with a debugging function and a test play function so as to upload the program and debugs problems of the program in advance.

FIG. 11 is a block diagram illustrating a compiler of the program development tool according to an exemplary embodiment of the present invention.

Referring to FIG. 11, the compiler includes scanners 1110, 1140, and 1170, parsers 1120, 1150, and 1180, an intermediate language generator 1130, an assembler generator 1160, and a binary code generator 1190.

The scanners 1110, 1140, and 1170 and the parsers 1120, 1150, and 1180 scan to read C/CPP source code or dedicated language code for generating the intermediate language, assembler, and binary code, and then directly generate a code during the passion process by a syntax indicative conversion or from an intermediate presentation such as ASP.

The intermediate language generator 1130 receives an input source program and generates an intermediate language code from the source code. The source program generates the intermediate presentation through semantic and grammatical analyses, and the intermediate generator 1130 translates the intermediate presentation into the intermediate language. At this time, the intermediate language generator 1130 verifies sentences during the semantic analysis and reports an error, if any errors, during the analysis such that the compiler user to correct the error. Only the sentences having neither syntax nor semantic error can be translated into the intermediate language. There are two intermediate language generation methods: the former directly generates a code through a syntax indicative conversion during the parsing process in the parsing process, and the latter generates a code from an intermediate presentation such as parse tree or abstract syntax tree (AST) generated in the middle of the passing process. Although AST and dedicated game intermediate language are used as the intermediate presentation and intermediate language, the present invention is not limited thereto.

The assembler generator 1160 generates an assembler through the intermediate language generation process, and the binary code generator 1190 generates a binary code through similar process.

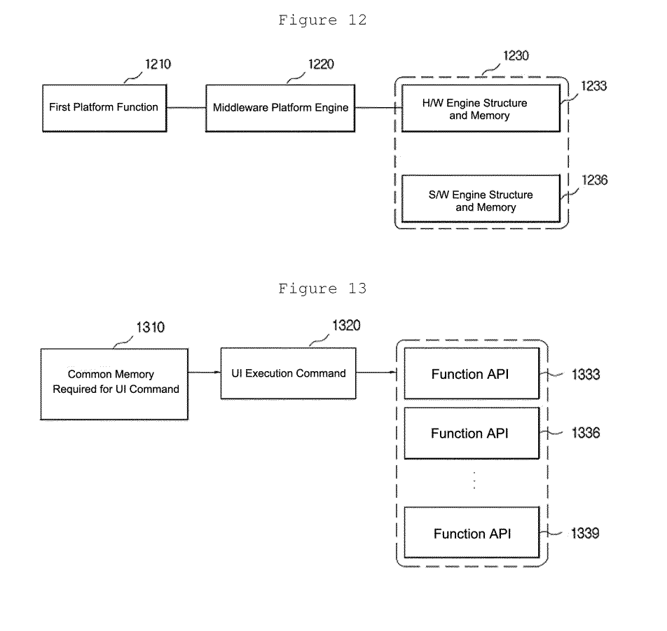

FIG. 12 is a block diagram illustrating a configuration of a memory utilization mechanism of the cross platform program porting apparatus according to an exemplary embodiment of the present invention. Referring to FIG. 12, the memory utilization mechanism includes a first platform function 1210, a middleware platform engine 1220, and a second platform structure 1230.

The first platform function 1210 and the middleware platform engine 1220 correspond to the API function (DirectX, OpenGL, OpenGL ES, and RenderWare) and the middleware platform engine described above.

The second platform structure 1230 is implemented differently with the memory structure according to the hardware and software, whereby the memory structure should be designed in consideration of the compatibility to the middleware platform engine 1220. For example, the multi write and bumper map is not supported in the OpenGL ES. In this case, the hardware memory structure is not compatible but software memory structure. Accordingly, the structure used in the software and the memory structure are assigned separately.

FIG. 13 is a block diagram illustrating a relationship between the UI tool and memory of the cross platform program porting apparatus according to an exemplary embodiment of the present invention. Referring to FIG. 13, a common memory 1310, a UI execution command 1320, and function APIs 1333, 1336, and 1339 are depicted.

The functions are called by means of commands generated at the UI too, and the called function is accessed with a pointer. In this case, information exchange is performed through the common memory 1310 required for the UI command. That is, the common memory 1310 required for the UI command acts as a media through which the variable and structure are propagate.

Accordingly, the UI execution command 1320 refers to the common memory 1310 required for the UI command and calls the required function APIs 1333, 1336, and 1339.

As described above, the program-porting and cross platform program development method of the present invention are stored within a storage media and executed by a device such as a mobile handset to which the storage media is attached. Here, the storage media include magnetic and optical storage media such as a hard disc, a magnetic tape, a compact disc (CD), a video CD (VCD), a digital video disc (DVD), and a database of a client or server computer deployed on an offline or online network.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

### INDUSTRIAL APPLICABILITY

The present invention can be applied to various application programming fields for porting a program such that the program can be executed in the devices operating on different platforms.

1. A method for porting an API from a source middleware platform to a target middleware platform, comprising:
storing index numbers assigned a plurality of source APIs in a memory associated with a source middleware platform;
extracting at least one of the indexes, which is required for generating a target API and corresponds to the source API; and
generating the at least one target API using the at least source API indicated by the at least one index.

2. The method of claim 1, wherein storing index numbers comprises extracting at least one code executable on a target middleware platform engine and storing the at least one code.

3. The method of claim 2, wherein calling one of the indexes comprises extracting at least one target code corresponding to the at least one index.

4. The method of claim 3, wherein generating at least one target API comprises creating the at least one target API by combining the at least one target code.

5. A middleware platform engine for porting application programming interfaces between devices having different middleware platforms, comprising:
a storage unit for assigning index numbers to a plurality of source APIs and storing the index numbers within a memory;
an index caller for calling at least one index number of at least one source API corresponding to at least one target API;
an API generator for generating the at least one target API using the at least source one API indicated by the at least one index.

6. The middleware platform engine of claim 5, wherein the storage unit extracts at least one code executable on a target middleware platform from the at least one source API.

7. The middleware platform engine of claim 6, wherein the index caller extracts at least one code corresponding to the at least one index number.

8. The middleware platform engine of claim 7, wherein the API generator generates the at least one target API by combining the at least on target code.

9. The middleware platform engine of claim 5, further comprising at least one of a graphic library, a media library, a physics library, and an artificial intelligence (AI) library, corresponding to a structure of the at least one target API.

10. The middleware platform engine of claim 9, wherein the media library is a graphic library or a sound library.
